(19) United States
(12) Patent Application Publication
(10) Pub. No.: US 2008/0148748 A1
(43) Pub. Date: Jun. 26, 2008

(54) HEATING SYSTEM FOR TRANSPORT REFRIGERATION UNIT

(75) Inventors: Herman H. Viegas, Bloomington, MN (US); David W. Augustine, Chanhannsen, MN (US)

Correspondence Address: MICHAEL BEST & FRIEDRICH LLP, 100 E WISCONSIN AVENUE, Suite 3300, MILWAUKEE, WI, 53202, US

(73) Assignee: THERMO KING CORPORATION, Minneapolis, MN (US)

(21) Appl. No.: 11/960,134

(22) Filed: Dec. 19, 2007

Related U.S. Application Data
(60) Provisional application No. 60/876,449, filed on Dec. 21, 2006.

(51) Int. Cl. F25B 29/00; F25D 23/12; F25D 21/06; B60H 1/32

(52) U.S. Cl. 62/151; 62/259.1; 62/159; 62/239

(57) ABSTRACT

A temperature control system for a vehicle that defines a load space for supporting cargo. The temperature control system includes a refrigeration unit that has a refrigeration circuit, and a heating system that has a heating circuit. The refrigeration circuit includes a prime mover and a cooling coil that selectively cools an airflow entering the load space. The heating circuit includes a pump that circulates a coolant fluid through the heating circuit, a dedicated heater that heats the coolant fluid, and a heating coil that selectively heats the airflow entering the load space. The temperature control system also includes a controller that detects conditions of the load space, and that engages one of the refrigeration unit and the heating system to condition the load space in response to the detected conditions.

### RELATED APPLICATIONS

This patent application claims priority to U.S. Patent Application Ser. No. 60/876,449 filed Dec. 21, 2006, the entire contents of which are hereby incorporated by reference.

### BACKGROUND

The present invention relates to temperature control systems, and more particularly to a transport temperature control system with a heating circuit and a method of operating the system.

In conventional mechanical refrigeration units, a diesel/compressor power pack within the unit has been utilized to also provide heat to a load space of a transport unit. However, the existing diesel/compressor power packs often do not provide adequate heat to the load space, particularly in cold ambient temperatures.

### SUMMARY

In one embodiment, the invention provides a temperature control system for conditioning at least one load space that supports cargo. The temperature control system includes a refrigeration unit that has a refrigeration circuit, and a heating system that has a heating circuit. The refrigeration circuit includes a prime mover that is operable to circulate a refrigerant through the refrigeration circuit, and a cooling coil that is in communication with the at least one load space to cool the load space. The heating circuit includes a pump that circulates a coolant fluid through the heating circuit, and a dedicated heater that is in communication with the coolant fluid to heat the coolant fluid. The heating circuit also includes a heating coil that is in communication with the at least one load space to heat the load space. The temperature control system also includes at least one air mover and a controller. The air mover directs an airflow across the cooling coil and the heating coil to condition the airflow via heat transfer with one of the refrigerant in the cooling coil and the coolant fluid in the heating coil prior to entry of the airflow into the at least one load space. The controller is in communication with the load space to detect conditions of the load space, and is further in communication with the refrigeration unit and the heating system to engage one of the refrigeration unit and the heating system to condition the load space in response to the detected conditions.

In another embodiment, the invention provides a method of conditioning at least one load space that supports cargo. The method includes providing a temperature control system that includes a refrigeration unit that has a refrigeration circuit with a prime mover and a cooling coil, and a heating system that has a dedicated heater and a heating coil. The method also includes circulating a refrigerant through the cooling coil, circulating a coolant fluid through the heating coil using a pump, and directing an airflow across at least one of the cooling coil and the heating coil using an air mover. The method further includes detecting conditions of the at least one load space, selectively operating the temperature control system in one of a cooling mode and a heating mode to condition the load space based on the detected load space conditions, and cooling the airflow via heat exchange relationship with the refrigerant flowing through the cooling coil during operation of the temperature control system in the cooling mode. The method also includes heating the coolant fluid in the heating circuit using the dedicated heater and heating the airflow via heat exchange relationship with the heated coolant fluid flowing through the heating coil during operation of the temperature control system in the heating mode, and conditioning the at least one load space using the airflow conditioned by one of the cooling mode and the heating mode.

In yet another embodiment, the invention provides a vehicle that includes a frame, and an outer wall that is coupled to the frame and that defines at least one load space supporting cargo. The vehicle also includes a temperature control system coupled to the outer wall and in communication with the load space. The temperature control system includes a refrigeration unit that has a refrigeration circuit, a heating system that has a heating circuit, and at least one air mover. The refrigeration circuit includes a prime mover that is operable to circulate a refrigerant through the refrigeration circuit, and a cooling coil that is in communication with the at least one load space to cool the load space. The heating circuit includes a pump that circulates a coolant fluid through the heating circuit, a dedicated heater that is in communication with the coolant fluid to heat the coolant fluid, and a heating coil that is in communication with the at least one load space to heat the load space. The air mover is in communication with the cooling coil and the heating coil to condition an airflow directed across the cooling coil and the heating coil via heat transfer with one of the refrigerant in the cooling coil and the coolant fluid in the heating coil prior to entry of the airflow into the at least one load space. The temperature control system further includes a controller that is in communication with the at least one load space to detect conditions of the load space. The controller is also in communication with the refrigeration unit and the heating system to engage one of the refrigeration unit and the heating system to condition the load space in response to the detected load space conditions.

Other aspects of the invention will become apparent by consideration of the detailed description and accompanying drawings.

### BRIEF DESCRIPTION OF THE DRAWINGS

FIG. 1 is a side view of a vehicle including a trailer having a temperature control system.

FIG. 2 is a side view of the trailer and the temperature control system with portion of an outer wall of the trailer cut-away.

FIG. 3 is a schematic diagram of a portion of a refrigeration circuit and a heating circuit of the temperature control system of FIG. 2.

FIG. 4 is a schematic diagram of the refrigeration circuit and the heating circuit of the temperature control system of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

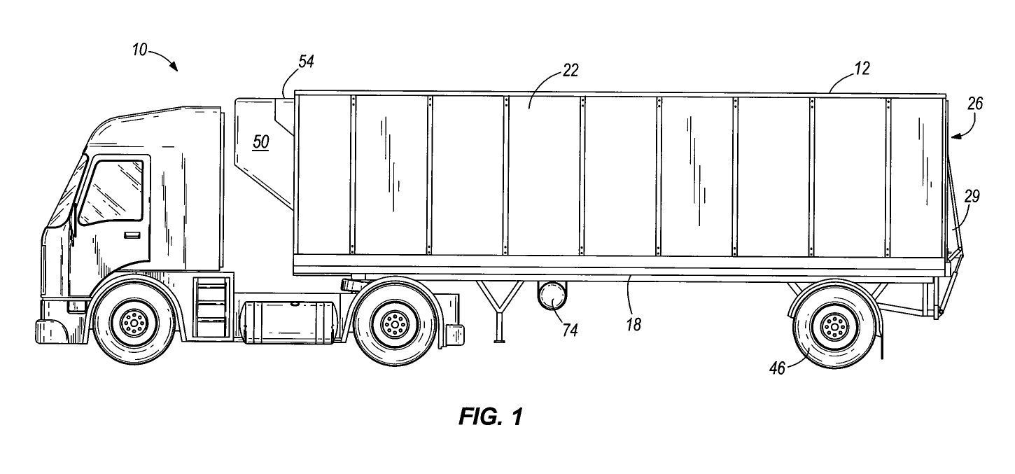

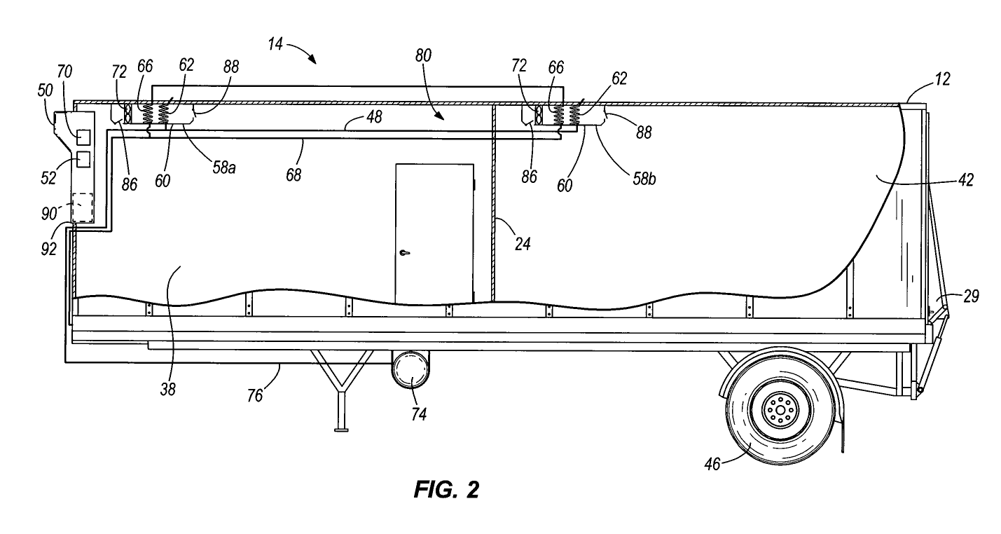

FIGS. 1 and 2 illustrate an exemplary vehicle 10 that includes a trailer 12, and a temperature control system 14 according to an embodiment of the invention. The illustrated vehicle 10 is a semi-tractor that is used to transport cargo, and that is coupled to the trailer 12 in a tractor-trailer combination. In other constructions, the vehicle 10 can be a truck, a shipping container, a rail container, or other transport vehicles (e.g., straight truck, van, etc.) that store and/or carry goods that must be maintained in a temperature controlled environment.

As shown in FIG. 1, the trailer 12 includes a frame 18 and an outer wall 22 supported on the frame 18 for substantially enclosing a temperature controlled load space 26. Doors 29 are supported on the frame 18 for providing access to the load space 26. Referring to FIG. 2, in some embodiments, the load space 26 can include a partition or an internal wall 24 for at least partially dividing the load space 26 into sub-compartments, including two or more load space zones 38, 42, each of which can be maintained at a different temperature or a different humidity, as described in greater detail below. A plurality of wheels 46 are provided on the frame 18 to permit movement of the vehicle 10 across the ground. In some constructions, wheels and/or rails for a railroad or a boat vessel can be used for transporting temperature controlled containers.

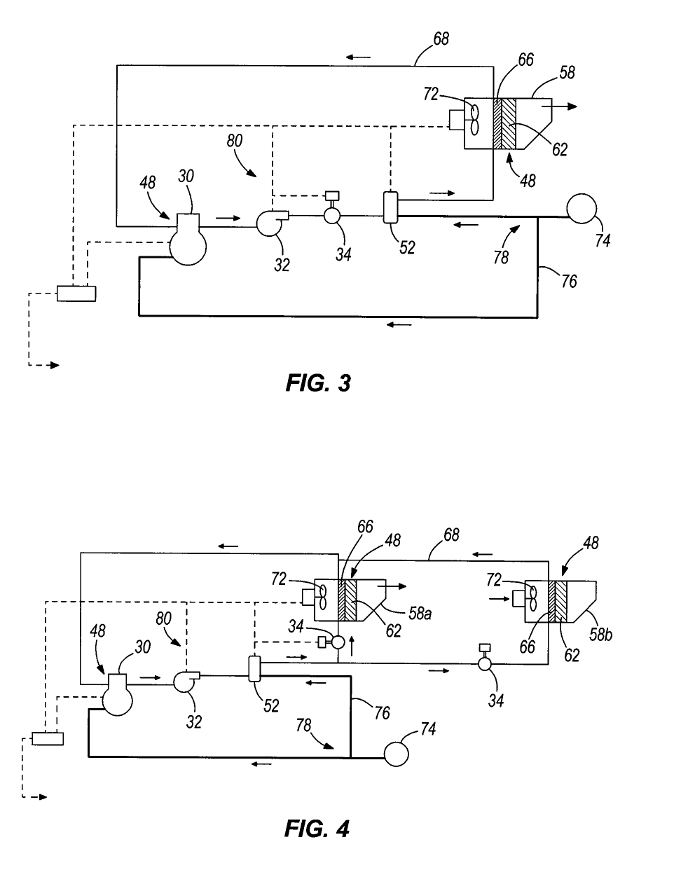

In the illustrated embodiment of FIGS. 1 and 2, the temperature control system 14 includes a mechanical refrigeration unit 50 that conditions the load space 26. The refrigeration unit 50 includes a refrigeration circuit 48 and a heating circuit 68. FIGS. 3 and 4 show a portion of the refrigeration circuit 48 that includes a cooling coil 62. The temperature control system 14 is provided with a heating system 80 that has a heater 52. The heater 52 may be a fuel fired heater that provides a source of heat whenever heat is required by the temperature control system 14. Typically heat is required either for heating the load space 26 or for defrosting evaporator or cooling coils 62 utilized in the refrigeration unit 50 of the temperature control system 14. The heater 52 can use fuel combustion, electrical resistance, or various other sources to provide heat.

The heater 52 can be located in several locations. In one embodiment the heater is located within an outer housing 54 of the refrigeration unit 50. By locating the heater 52 in this region, heat transfer fluid or coolant used for cooling an engine or prime mover 30 that powers the refrigeration unit 50 can be conveniently utilized to transfer heat from the heater 52 to a region adjacent the load space 26. Utilizing fluid in this manner enables the temperature control system 14 to transfer heat either into or away from the region adjacent the load space 26 at different times depending on requirements of the system 14 and/or requirements in the load space. The heater 52 might also be attached to the outer wall 22 or suspended from the frame 18, in the load space 26, or at various other locations.

The temperature control system 14 will generally direct refrigerant from the refrigeration unit 50 through a continuous loop refrigerant conduit to the load space 26 or the region where the temperature is to be controlled. The temperature control system 14 includes one or more evaporator/heater units or heat exchanger assemblies 58. In the illustrated embodiment of FIGS. 1 and 2, the temperature control system 14 includes a first heat exchanger assembly 58a positioned in a first load space zone 38 and a second heat exchanger assembly 58b positioned in a second load space zone 42. In other embodiments, the temperature control system 14 can include one, three, or more heat exchanger assemblies 58 positioned in one, three, or more load space zones.

In the construction illustrated in FIGS. 1 and 2, the first and second units 58a, 58b are substantially similar. Accordingly, while the following description makes reference to elements of the first heat exchanger assembly 58a, it should be understood that the second heat exchanger assembly 58b can be identical or similar or alternatively include substantially similar elements. Similarly, additional heat exchanger assemblies and additional load space zones will be similar to the heat exchanger assembly 58a and the load space 26.

As shown in FIG. 2, the first heat exchanger assembly 58a can include an evaporator housing 60, a cooling coil 62, and a heating coil 66. The coils 62, 66 are contained in the evaporator housing 60. The cooling coil 62 is fluidly connected to and positioned along a refrigeration circuit 48. The heating coil 66 is connected to and positioned along the heating circuit 68. The housing 60 can include an air inlet 86 and an air outlet 88 for receiving air from, and returning air to, the load space 26. The housing 60 can also support a fan or blower or air mover 72 for drawing load space air into the evaporator housing 60 through the air inlet 86. The air mover 72 moves the air across the coils 62, 66 and returns the air to the load space 26 through the air outlet 88. In some constructions, the cooling coil 62 and the heating coil 66 can be positioned within a compartment of the housing 60 as an integral unit.

As mentioned above, and in contrast to the cooling coil 62, the heating coil 66 is connected to and positioned along a different fluid heating circuit 68. The heating circuit 68 is provided to integrate an efficient and controllable means of transferring heat to the heating coil 66 when it is necessary to either heat the load space 26 or to defrost the cooling coils 62 and the heating coils 66. Through utilization of a specific purpose heating circuit 68 with the separately powered heater 52, the heating process can be accomplished more efficiently. The heating circuit 68 may be wholly self-contained or it may be a circuit that is extended from an existing fluid circuit (e.g., a cooling circuit for the prime mover 30).

FIG. 3 shows a portion of the heating circuit 68. In one construction, the fluid used for the heating circuit 68 comes from the prime mover 30. This is commonly a diesel engine of conventional design. However, the prime mover 30 that is used for the cooling circuit 62 can be of various types and may not necessarily be appropriate for providing coolant for a different purpose (e.g., heating). Using the coolant from the prime mover 30 is not necessary, but it can be a convenient source. One advantage of this arrangement is it avoids duplication of cooling fluids. The coolant fluid of the prime mover 30 will generally have appropriate thermodynamic characteristics so that the coolant fluid can be used to cool or heat the prime mover via heat exchange relationship, and to selectively heat the load space 26. However, other embodiments might use a separate independent fluid source for the heating circuit 68 for various reasons.

The heating circuit 68 as shown in FIG. 3 provides heat to a single area or load space 26. FIG. 4 shows the heating circuit in configuration for delivering heat to two areas or load space zones 38, 42.

Referring back to FIG. 3, the coolant fluid used to cool the prime mover 30 is drawn from the prime mover 30 through the heating circuit 68. The heating circuit flow path continues from the prime mover 30, through a pump 32 and a flow control valve 34 and adjacent or into the heater 52 where the coolant fluid is heated. In one embodiment, heating the coolant fluid in the heater 52 is accomplished through a conventional and relatively direct fuel-fired heating process. After the coolant fluid is heated and passed through the heater 52, it continues on to the heat exchanger assembly 58 and into the heating coil 66. At the heating coil 66, an airflow is directed from the air mover 72 over the heating coil 66 and into the load space 26. This is an efficient means of heating air that is directed into the load space 26 for the purpose of maintaining conditions of the load space 26 within desired parameters without operating the prime mover 30.

In the event that heating is required for defrosting the cooling coil 62, the airflow is interrupted and not directed into the load space 26. Rather, an entry area into the load space 26 is closed, and heat is retained in the region of the cooling coil 62 to provide greater heat transfer to the cooling coil 62 in order to defrost the cooling coil 62. In the same manner, the heating coil 66 can be defrosted.

After passing through the heating coil 66, the coolant fluid is then returned through a complete circuit to the prime mover 30 and the process continues as the coolant fluid is continuously circulated through the continuous loop heating circuit 68.

The heating process is initiated when a control unit or controller 70 of the vehicle 10 calls for a heating process, either to heat the load space 26 or to defrost the cooling coil 62. When the controller 70 calls for heating, the supplemental cooling pump 32 is activated, the valve 34 is opened, and begins circulating coolant fluid. The heater 52 is activated and heats the coolant fluid. In some constructions, a coolant pump coupled to the prime mover cooling system may suffice to provide circulation. In these constructions, the coolant pump may replace the pump 32.

Once the heating process is started, components of the vehicle 10 that are powered by electricity are generally supplied with electricity from an alternator or generator powered by a vehicle engine (not shown). Alternatively, these items can be powered by a battery or other source of electrical power. Electrically powered components can include the motorized air mover 72 located at the cooling and heating coils 62, 66 to move the airflow over the cooling and heating coils 62, 66 into the load space 26, as well as other components described herein. When a defrost mode of the controller 70 is utilized, the air movers 72 can be turned off, and in some constructions, a damper can be used to stop warm air from entering the load space 26.

Throughout the heating process, the heater 52 provides efficient and continuous heat transfer to the coolant fluid. As mentioned above, the heater 52 requires a source of heat energy. In some constructions, a fuel tank 74 may be carried beneath the trailer 12 (See FIGS. 1 and 2). In other constructions, the fuel tank 74 for the heater 52 can be disposed at various other locations on the vehicle 10. A fuel line 76 directs fuel to the heater 52. It may be advantageous to utilize the same fuel that is used to power the prime mover 30 to also power the heater 52. Typically, both the prime mover 30 and the heater 52 use diesel fuel. In the event that both of them are diesel fuel powered, it is very convenient to use the same fuel tank (e.g., fuel tank 74) and the same fuel circuit. As shown in FIGS. 3 and 4, a fuel circuit 78 extends from the fuel tank 74 and carries fuel directly to the heater 52 and the prime mover 30 The illustrated heater 52 can be, for example, an Espar Hydronic Model 5™, although other heaters are possible and considered herein.

The controller 70 can be programmed to operate the temperature control system 14 in a cooling mode or a heating mode to maintain or achieve a desired set point temperature and/or set point humidity level in the load space zones 38, 42. Each load space zone 38, 42 can be independently maintained and at different set point conditions.

During operation of the temperature control system 14 in the cooling mode by the controller 70, the refrigerant circulates through the refrigeration circuit 48 to the cooling coil 62 of the first heat exchanger assembly 58a and/or the second heat exchanger assembly 58b. The air mover 72 draws air from the load space 26, into the evaporator housing 60 through the inlet 86. The air mover 72 then directs the airflow across the cooling coil 62 to cool the airflow via heat exchange between the cooling coil 62 and the airflow, and returns the cooled or conditioned airflow to the load space 26 through the air outlet 88. As the refrigerant travels through the cooling coil 62, the refrigerant absorbs heat energy from the airflow directed across the cooling coil 62. The refrigerant is then circulated through the remaining portions of the refrigeration circuit 48.

The prime mover 30 is cooled by the coolant fluid flowing through a coolant circuit (not shown) during operation of the temperature control system 14 in the coolant mode. The coolant fluid is bypassed around the heating coil 66 via the coolant circuit to avoid heating the airflow entering the load space 26 during operation of the temperature control unit 14 in the cooling mode.

During operation of the heating system 80 in the heating mode by the controller 70 (shown schematically in FIG. 3), the heater 52 heats the coolant fluid in the heating circuit 68. The heated coolant fluid flows through the heating coil 66, and heats the airflow via heat exchange relationship. The coolant fluid then circulates through the heating circuit 68 to be reheated by the heater 52 as necessary.

During operation of the temperature control system 14 in the defrost mode, the controller 70 may cause the dampers adjacent the air inlet 86 and the air outlet 88 of each heat exchanger assembly 58a, 58b to be closed, and/or the air movers 72 to be shut down to prevent and/or limit movement of heat from the respective heat exchanger assembly 58a, 58b into the load space zones 38, 42. Alternately, the speed of the air movers 72 can be decreased during the defrost mode. The heater 52 then heats the coolant fluid in the heating circuit 68, and the coolant fluid is then pumped by the pump 32 through the heating circuit 68 to the heating coil 66 of the first heat exchanger assembly 58a and/or the second heat exchanger assembly 58b. Heat from the heating coil 66 then defrosts and/or thaws the adjacent cooling coil 62 in the first heat exchanger assembly 58a and/or the second heat exchanger assembly 58b, as well as the heating coil 66 if frost has built up on the heating coil 66.

The controller 70 can be programmed to initiate operation of the refrigeration unit 50 in the defrost mode based upon one or more sensed conditions (e.g., a pressure change of air flowing across the cooling coils 62, a temperature change in the evaporator housing 60, etc.). Alternatively, the defrost mode can be initiated by the controller 70 at predetermined time intervals (e.g., every 4 hours, etc.). Each heat exchanger assembly 58a, 58b can be independently defrosted by the associated heating circuit 68 based upon the sensed conditions of the associated load space zone, or at the predetermined time interval(s).

In FIG. 2, the heating system 80 is in communication with two load space zones 38, 42. Similarly, the refrigeration unit 50 is in communication with the two load space zones 38, 42. Various modes of operation are possible with the circuits shown in FIG. 4. For example, the heating system 80 and the refrigeration unit 50 can be selectively operated by the controller 70 to cool the load space zones 38, 42. Alternatively, the heating system 80 and the refrigeration unit 50 can be operated by the controller 70 to heat the load space zones 38, 42, to defrost the two cooling coils 62, or any combination thereof (e.g., heat one load space zone and cool the other load space zone, etc.). Each portion of the heating circuit 66 is provided with an independent heating coil 66 and an independent flow control valve 34 for the purpose of controlling the flow of the coolant fluid through the two circuits 66 in order to accommodate various modes of operation.

In some constructions, a separate, independent coolant fluid can be used in heating circuit 68. It is not necessary to utilize the coolant fluid of the prime mover 30. For example, a food grade coolant fluid can be used in the heating circuit 68. In this construction, the prime mover 30 is not in communication with the heating circuit 68.

It may be advantageous to use the prime mover 30, at various times, to keep a battery pack (e.g., a deep cycle battery pack) charged for powering electrical components of the vehicle 10. Commonly, the battery pack can be charged during operation of the truck or trailer through a circuit carried from a main vehicle engine electrical system (not shown) and/or an engine of the trailer 12 (e.g., the prime mover 30). For tractor-trailer applications, the tractor 10 is coupled to the trailer 12 to provide the electrical power for lights and other accessories, and an engine (e.g., the prime mover 30) of the trailer 12 provides power to the electrical components of the trailer 12. In some constructions, the main vehicle engine drives an alternator sufficiently sized to power an electrically-driven compressor, condenser, and evaporator fan or blower unit, and to power electrical components for cooling, heating, and defrosting. However, there are times when the main vehicle engine is not operating, and in these circumstances, the prime mover 30 may be used to charge the battery pack. Thus, continuous operation of a vehicle engine and/or alternator can be avoided.

Alternatively, or in addition, the temperature control system 14 can include a dedicated power source 90 (e.g., a fuel cell, etc.), for supplying power to the controller 70, the air movers 72, and other electrical power-consuming elements. In the illustrated construction, the power source 90 includes a deep cycle battery pack. In other constructions, fuel cells and/or other dedicated power sources can be located in other locations in the vehicle 10 (e.g., on the frame 18, under the load space 26, in the load space 26, on the outer wall 22 of the vehicle 10, etc.).

In some constructions, the temperature control system 14 can include a receptacle 92 for receiving power from external power sources. In these constructions, an engine or battery of the vehicle 10 can supply electrical power to the controller 70, the air movers 72, and/or other electrical power-consuming elements. As shown in FIGS. 1 and 2, the temperature control unit 14 can also, or alternatively, use the receptacle 92 for receiving power from a land-based power network (e.g., the power network of a truck depot) for supplying electrical power to the controller 70, the air movers 72, and/or other electrical power-consuming elements of the temperature control system 14.

In constructions that include the receptacle 92 for receiving power from a land-based power network, the temperature control unit 14 may include an adaptor to facilitate an electrical connection between the receptacle 92 and various land-based power networks. For example, the adaptor can be engageable with a 120 volt alternating current (“VAC”) circuit and/or with a 230 VAC circuit. In other constructions, the temperature control system 14 can include separate receptacles for engaging various standard land-based power networks.

Various features and advantages of the invention are set forth in the following claims.

1. A temperature control system for conditioning at least one load space supporting cargo, the temperature control system comprising:
a refrigeration unit including a refrigeration circuit having a prime mover operable to circulate a refrigerant through the refrigeration circuit, and a cooling coil in communication with the at least one load space to cool the load space;
a heating system including a heating circuit having a pump operable to circulate a coolant fluid through the heating circuit, the heating circuit further having a dedicated heater in communication with the coolant fluid to heat the coolant fluid, and a heating coil in communication with the at least one load space to heat the load space;
at least one air mover in communication with the cooling coil and the heating coil, the air mover operable to direct an airflow across the cooling coil and the heating coil to condition the airflow via heat transfer with one of the refrigerant in the cooling coil and the coolant fluid in the heating coil prior to entry of the airflow into the at least one load space; and
a controller in communication with the at least one load space to detect conditions of the load space, the controller further in communication with the refrigeration unit and the heating system to engage one of the refrigeration unit and the heating system to condition the load space in response to the detected conditions.

2. The temperature control system of claim 1, further comprising an evaporator housing, wherein the cooling coil and the heating coil are disposed in the evaporator housing, and wherein the air mover is attached to the evaporator housing adjacent the cooling coil and the heating coil.

3. The temperature control system of claim 1, wherein the coolant fluid includes a food grade coolant fluid.

4. The temperature control system of claim 1, wherein the heating circuit is in communication with the prime mover, and wherein the coolant fluid is in heat exchange relationship with the prime mover to cool the prime mover via heat exchange when the prime mover is operating.

5. The temperature control system of claim 4, wherein the coolant fluid is in communication with the prime mover to heat the prime mover via heat exchange when the prime mover is not operating.

6. The temperature control system of claim 1, wherein the coolant fluid in the heating circuit is a first coolant fluid, and wherein the prime mover is in heat exchange relationship with a second coolant fluid that is separate and independent from the first coolant fluid.

7. The temperature control system of claim 1, wherein the controller is in communication with the cooling coil to detect frost conditions of the cooling coil, and wherein the heating coil is in communication with and positioned adjacent the cooling coil to selectively defrost the cooling coil in response to the detected frost conditions.

8. The temperature control system of claim 6, wherein the air mover is disengaged in response to defrost of the cooling coil.

9. The temperature control system of claim 1, wherein the heater includes a diesel-fired heater.

10. A method of conditioning at least one load space supporting cargo, the method comprising:
providing a temperature control system, the temperature control system including a refrigeration unit having a refrigeration circuit, the refrigeration circuit having a prime mover and a cooling coil, the temperature control system further including a heating system having a dedicated heater and a heating coil;
circulating a refrigerant through the cooling coil;
circulating a coolant fluid through the heating coil using a pump;
directing an airflow across at least one of the cooling coil and the heating coil using an air mover;
detecting conditions of the at least one load space;
selectively operating the temperature control system in one of a cooling mode and a heating mode to condition the at least one load space based on the detected load space conditions;
cooling the airflow via heat exchange relationship with the refrigerant flowing through the cooling coil during operation of the temperature control system in the cooling mode;
heating the coolant fluid in the heating circuit using the dedicated heater and heating the airflow via heat exchange relationship with the heated coolant fluid flowing through the heating coil during operation of the temperature control system in the heating mode; and
conditioning the at least one load space using the airflow conditioned by one of the cooling mode and the heating mode.

11. The method of claim 10, further comprising
detecting defrost conditions of the cooling coil;
selectively operating the temperature control system in a defrost mode in response to the detected defrost conditions; and
defrosting the cooling coil in the defrost mode.

12. The method of claim 11, further comprising
operating the temperature control system in the heating mode;
heating the coolant fluid in the heating circuit; and
heating the cooling coil via heat exchange relationship with the heated coolant fluid in the heating circuit.

13. The method of claim 11, further comprising one of disengaging the air mover and slowing the speed of the air mover in response to operation of the temperature control system in the defrost mode.

14. The method of claim 10, further comprising drawing air from the at least one load space prior to directing the airflow across at least one of the cooling coil and the heating coil.

15. The method of claim 10, further comprising
directing the coolant fluid through the prime mover; and
warming the prime mover via heat exchange with the coolant fluid when the prime mover is not operating.

16. The method of claim 10, further comprising
activating the pump and circulating the coolant fluid through the heating circuit in response to operation of the temperature control system in the heating mode; and
deactivating the prime mover.

17. The method of claim 10, further comprising
circulating a first coolant fluid through the heating circuit; and
circulating a second coolant fluid that is separate and independent from the first coolant fluid through the prime mover.

18. The method of claim 10, further comprising supplying fuel to the prime mover and the dedicated heater from a single fuel tank.

19. A vehicle comprising:
a frame;
an outer wall coupled to the frame and defining at least one load space configured to support cargo;
a temperature control system coupled to the outer wall and in communication with the at least one load space, the temperature control system including
a refrigeration unit having a refrigeration circuit, the refrigeration circuit including a prime mover operable to circulate a refrigerant through the refrigeration circuit, and a cooling coil in communication with the at least one load space to cool the load space,
a heating system including a heating circuit having a pump operable to circulate a coolant fluid through the heating circuit, the heating circuit further having a dedicated heater in communication with the coolant fluid to heat the coolant fluid, and a heating coil in communication with the at least one load space to heat the load space, and
at least one air mover in communication with the cooling coil and the heating coil, the air mover operable to direct an airflow across the cooling coil and the heating coil to condition the airflow via heat transfer with one of the refrigerant in the cooling coil and the coolant fluid in the heating coil prior to entry of the airflow into the at least one load space; and
a controller in communication with the at least one load space to detect conditions of the load space, the controller further in communication with the refrigeration unit and the heating system to engage one of the refrigeration unit and the heating system to condition the load space in response to the detected load space conditions.

20. The temperature control system of claim 19, further an internal wall that cooperates with the outer wall to define a first load space and a second load space, wherein the heating coil is a first heating coil and the heating circuit further includes a second heating coil, and wherein the coolant fluid heated by the dedicated heater is in communication with the first load space via the first heating coil, and with the second load space via the second heating coil such that the dedicated heater is operable to selectively heat the first load space and the second load space.
